(19) United States
(12) Patent Application Publication
(10) Pub. No.: US 2007/0029726 A1
(43) Pub. Date: Feb. 8, 2007

(54) Dice game machine

(76) Inventor: Teruo Ohira, Gifu-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 10/567,936

(22) PCT Filed: Aug. 5, 2004
(86) PCT No.: PCT/JP04/11563

§ 371 Date: Oct. 19, 2006

(30) Foreign Application Priority Data
Aug. 11, 2003 (JP) 2003-291002

(51) Int. Cl. G07C 15/00; A63F 7/04; A63F 9/04

(52) U.S. Cl. 273/145 R; 273/145 C; 273/144 A; 273/144 B; 273/146

(57) ABSTRACT

A dice game apparatus rolls dice to a stop, then photographs spots shown by the stopped dice with a CCD camera (41), then analyzes an image of the spots, and determines the spots shown by the dice. In the dice game apparatus, a dice rolling surface (35a) on which the dice are rolled is inclined downwardly from its outer periphery toward its center. The CCD camera (41) is disposed above the center thereof. As a result, the dice are gathered around the center in accordance with the inclination of the surface. An image of the upper sides of the dice substantially exactly facing the CCD camera (41) can be taken. Therefore, the spots shown by the dice can be analyzed more accurately.

### TECHNICAL FIELD

The present invention relates to a dice game apparatus in which a dice game is won or lost depending on the number of spots shown by dice that are actually rolled.

### BACKGROUND ART

Conventionally, there is a dice game apparatus in which dice are actually rolled, and spots shown by the dice determine the winning or losing of a dice game. In this case, to know how the dice have been actually rolled to a stop and have shown spots, the dice game apparatus takes an image including the dice by a CCD (Charge-Coupled Device) camera, and then analyzes the image by a computer. Japanese Patent No. 2813847 can be mentioned as an example of this type of dice game apparatus. In a dice game apparatus disclosed by this patent, dice that have been rolled on a saucer are stopped with a magnet, and are photographed with a CCD camera disposed at a predetermined position, so that spots shown by the dice are analyzed from a photographic image of the dice.

However, in the conventional dice game apparatuses including the apparatus disclosed by the patent, there has been a possibility that dice will disappear out of a photographic field angle of the camera if the dice are excessively scattered on the saucer and are stopped apart from each other. In this case, the number of spots of the dice cannot be determined, and the winning or losing of this dice game cannot be decided. If such a case frequently occurs, the amusingness or savor of the dice game will be considerably deadened. Another conventional problem is that the spots of the dice cannot be accurately analyzed even if the dice appear within the photographic field angle of the camera, because an image of the dice photographed at the corner position is taken as a distorted image.

These problems are solved by photographing the dice from a certain degree of distance, but if so, structural limitations will be imposed on the apparatus used as a game machine.

The present invention has been made to solve these problems. It is therefore an object of the present invention to provide a dice game apparatus capable of reliably photographing spots of dice that have been rolled to a stop from a short distance by use of a photographing means and capable of accurately analyzing an image of the spots.

### DISCLOSURE OF INVENTION

To solve the problems, a dice game apparatus of the present invention comprises a dice rolling means for rolling dice so as to change spots shown by the dice and then stopping the dice again; a photographing means for photographing the dice from a predetermined direction, the dice having been rolled by the dice rolling means and then having been stopped while showing given spots; and a judging means for judging spots shown by the dice based on image data obtained by the photographing means. Based on a judgment result produced by the judging means, the dice game apparatus provides a predetermined profit to a player who has placed a bet on the given spots shown by the dice. In the dice game apparatus, the rolling means has a rolling surface on which the dice are placed and rolled. The rolling surface is inclined downwardly from an outer periphery thereof toward a center thereof. The photographing means takes an image including upper sides of the dice gathering at a lower position of the rolling surface from an upper position of the rolling surface.

### BRIEF DESCRIPTION OF THE DRAWINGS

FIG. 1 is a perspective view of a dice game apparatus according to an embodiment of the present invention;

FIG. 2 is an explanatory drawing for explaining a dice rolling portion and the vicinity of a retractable dome in a transparent dome that is a main part of the game apparatus according to the embodiment;

FIG. 3 is a plan view showing a state in which the retractable dome is opened in the transparent dome;

FIG. 4 is a plan view showing a state in which the retractable dome is closed in the transparent dome;

FIG. 5 is a perspective view showing the interior of the transparent dome;

FIG. 6 is a front view of an electronic display panel;

FIG. 7 is a partial, longitudinal sectional view of the electronic display panel along line I-I of FIG. 6;

FIG. 8 is a partial, longitudinal sectional view of the electronic display panel along line II-II of FIG. 7;

FIG. 9 is a block diagram of an electric structure according to the embodiment; and

FIG. 10 is a cross-sectional view of an arch.

### BEST MODE FOR CARRYING OUT THE INVENTION

An embodiment of the present invention will be hereinafter described with reference to the accompanying drawings.

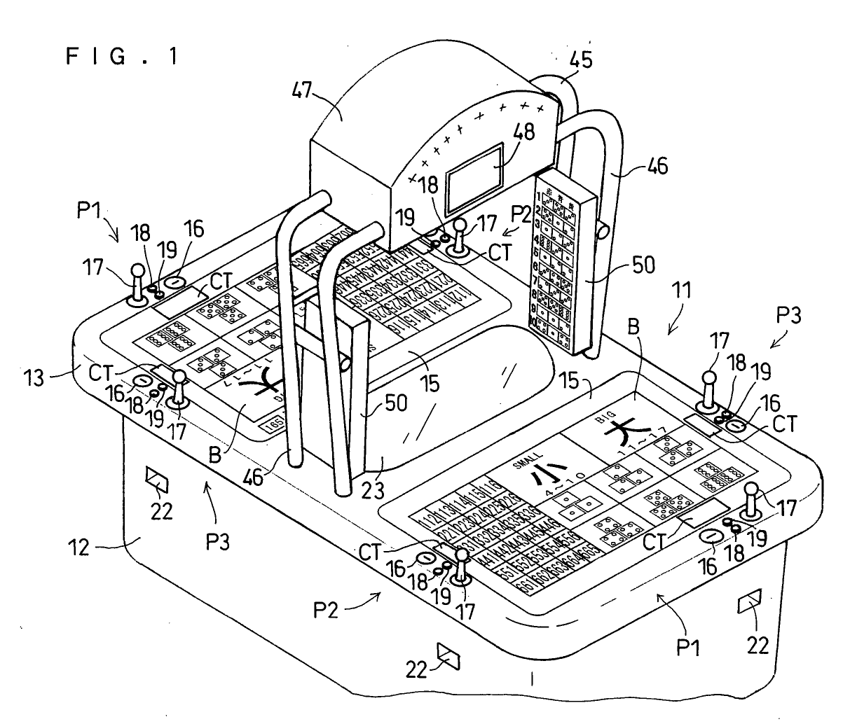

As shown in FIG. 1, a housing 11 forming a game apparatus is made up of a base 12 and a table 13 provided on the upper part of the base 12. Rectangular monitors 15 used for betting are formed in mutually opposite positions on the upper surface of the table 13. A betting board B, a counter CT that shows a credit amount or a bet amount to a player, etc., are displayed on the betting monitor 15.

A first play corner P1, a second play corner P2, and a third play corner P3 are disposed at three locations, respectively, around the periphery of the betting monitor 15. Each of the play corners P1 to P3 has a medal insertion slot 16 formed in the upper surface of the table 13, a joystick 17 serving as an operating means and as a selecting means, a hold button 18, a put button 19, etc. A medal payout port 22 is disposed at the side surface of the base 12 in each of the play corners P1 to P3. A medal payout device (not shown), and a detecting device (not shown), for detecting the number of medals inserted thereinto are disposed inside the base 12.

A transparent dome 23 is disposed on the upper surface of the table 13 between the mutually opposite monitors 15. The transparent dome 23 made of transparent plastic is a hemisphere shaped like a planar prolate ellipsoid as if a silkworm cocoon is bisected in a longitudinal direction and is laid down. A retractable dome (i.e., an openable and closable dome) 24, a dice rolling portion 25, and an arch 26 are contained in the transparent dome 23.

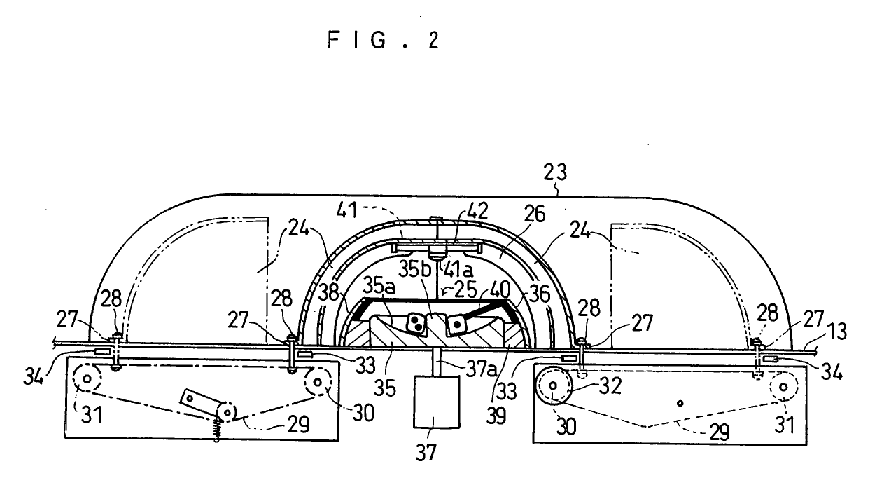

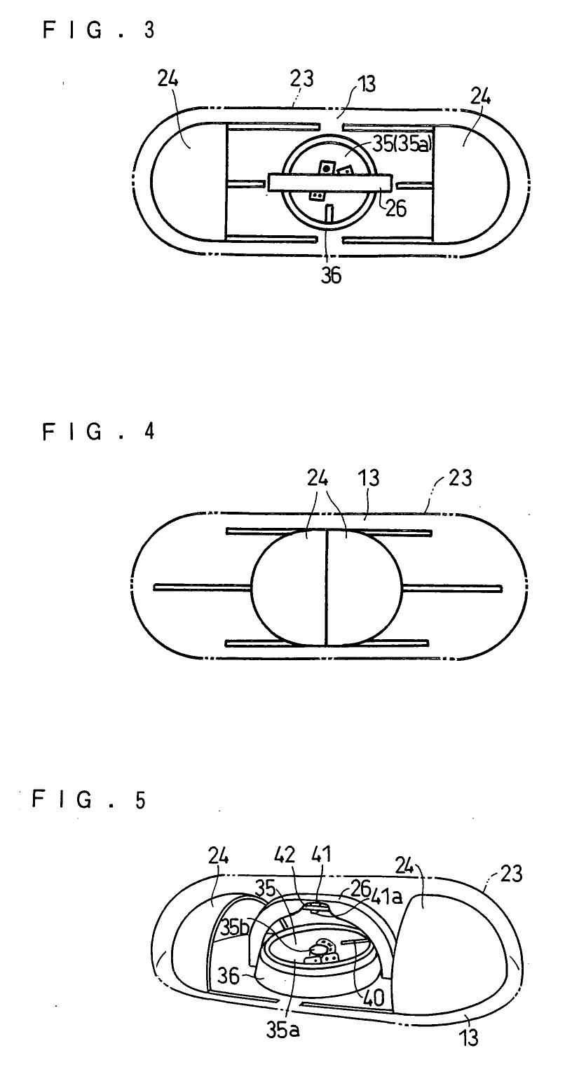

As shown in FIG. 2 to FIG. 5, the retractable dome 24 serving as a shielding member is a hemisphere formed in bisected planar elliptical shape. As shown in FIG. 2, a flange 27 disposed at the rear end of each of the roofs of the retractable dome 24 is connected to a chain 29 disposed inside the table 13 via a connection pin 28. The chain 29 is wound on a first sprocket 30 and a second sprocket 31. The chain 29 can be normally and reversely rotated via the sprockets 30 and 31 by driving a first motor 32. A first limit switch 33 and a second limit switch 34 are disposed near the first and second sprockets 30 and 31, respectively, so as to interfere with the connection pin 28. The first limit switch 33 is located at a position where the end faces of the roofs of the dome 24 come into exact contact with each other, whereas the second limit switch 34 is located at a position where the roofs of the dome 24 sufficiently recede from each other. As a result, the roofs of the dome 24 slide on the table 13, and hence the dome 24 can reach two states, i.e., an open state shown in FIG. 3 and a closed state shown in FIG. 4.

The dice rolling portion 25 and the arch 26 are disposed at the center of the inside of the transparent dome 23 so as to be blocked from the outside by the retractable dome 24 being in a closed state. The dice rolling portion 25 is made up of a rotational plate 35, a cover portion 36 surrounding the rotational plate 35, and a second motor 37 contained in the table 13. As shown in FIG. 2, a dice rolling surface 35a of the rotational plate 35 that is planar circular is shaped like a bowl that gradually becomes deeper from its rim toward its center and that has a gently curved slope toward the deepest center. A cylindrical pillar 35b is erected at the center of the dice rolling surface 35b. The tip of an output shaft 37a of the second motor 37 is connected to the center of the back surface of the rotational plate 35. As a result, the rotational plate 35 can rotate in the cover portion 36. The cover portion 36 is made up of an outer cover 38 bent in the direction of the rotational plate 35 and a bearing 39 surrounding the rotational plate 35. A flexible rod (in this embodiment, a rubber-made rod) 40 extends from the inner peripheral surface of the outer cover 38 toward the rotational plate 35. The rod 40 can interfere with dice rolled in accordance with the rotation of the rotational plate 35.

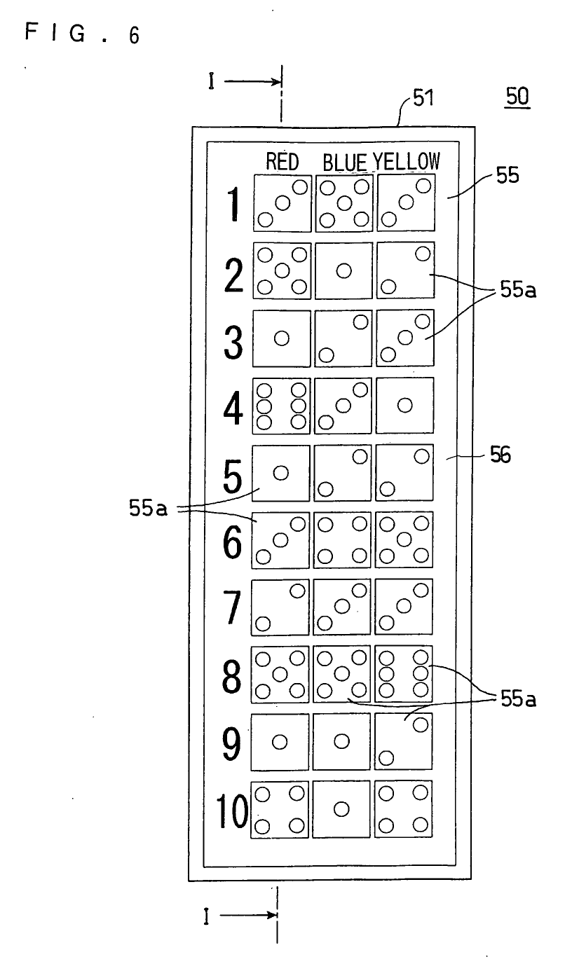

The arch 26 is disposed in such a manner as to step over the rotational plate 35 and the cover portion 36. As shown in FIG. 2, FIG. 5, and FIG. 10, the arch 26 is a plastic body integrally molded in the shape of inverted “U” in the cross section. A CCD camera 41 is disposed at the center of the upper part of the arch 26. In the CCD camera 41 in this embodiment, a wide-angle lens 41a is used as a lens so as to enlarge a photographic range (field angle). A pair of cold-cathode tubes 42 that serve as light sources used when the retractable dome 24 is closed are disposed in front of and behind the CCD camera 41 so as to sandwich the CCD camera 41.

As shown in FIG. 1, an arcade 45 is disposed at the center of the table 13 in a state of being overlapped with the transparent dome 23. The arcade 45 is made up of arms 46 erected slightly apart from the outside of both ends of the transparent dome 23 and an illumination panel 47 supported by bent upper parts of the arms 46. The illumination panel 47 is disposed directly above the transparent dome. Small monitors 48 on which images taken by the CCD camera 41 are displayed are embedded in the front and back surfaces, respectively, of the illumination panel 47. Light-emitting means, such as lamps, not shown, are contained in the illumination panel 47 used also as an advertising tower. The light-emitting means blink in response to the progression of the game, and produces a predetermined illuminative, congratulatory effect.

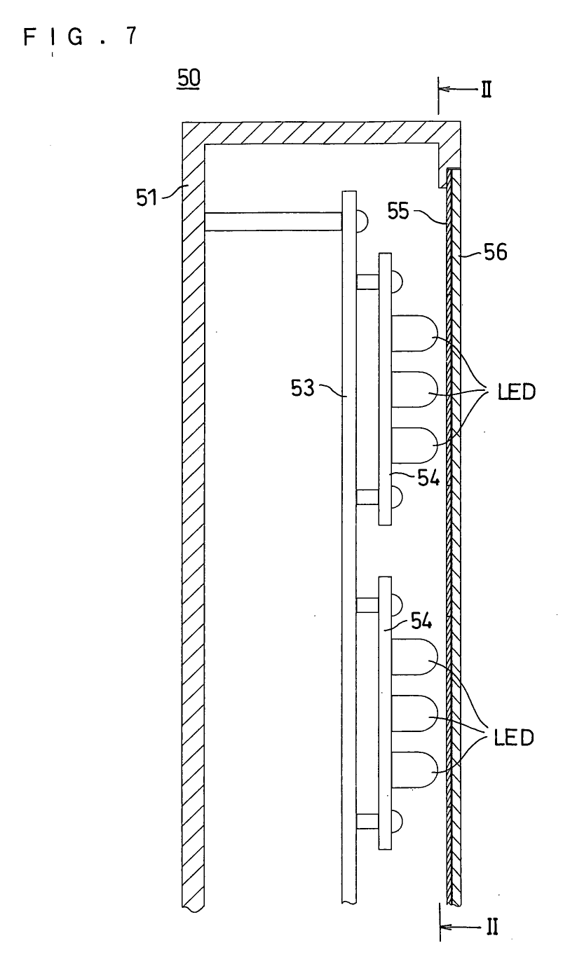

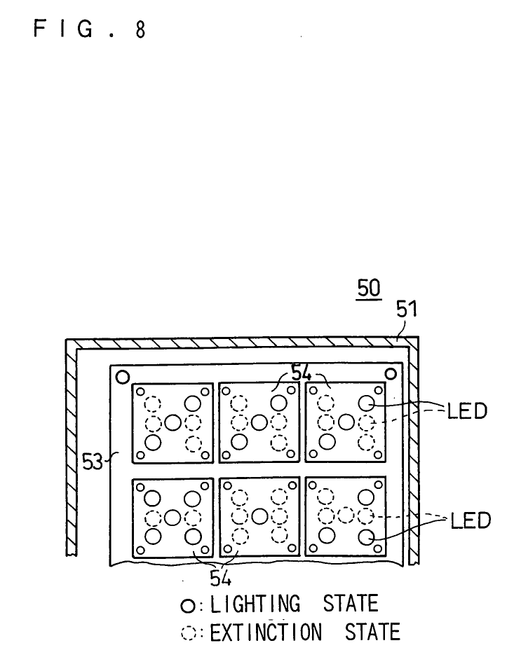

Electronic display panels 50 are erected on the table 13 in a state of adjoining the inside of the arms 46. As shown in FIG. 7 and FIG. 8, an LED unit 53 is disposed inside a body case 51 of the electronic display panel 50. In the LED unit 53, an LED board 54 having seven LEDs (Light Emitting Diodes), which correspond to the number of spots of dice and to the positions of the dice, is used as a unit. Since the number of dice used in the game is three in this embodiment, three LED boards 54 are disposed in the lateral direction as shown in FIG. 6 so that spots shown by the three dice can be displayed. Additionally, in this embodiment, the history of spots shown by the dice for ten dice games in the past is electronically displayed in the longitudinal direction. In other words, the LED unit 53 is composed of thirty LED boards 54 in total.

As shown in FIG. 6 and FIG. 7, a translucent plate 55 is mounted on the front of the body case 51 in such a manner as to cover the LED unit 53. The LED boards 54 are disposed behind square LED translucent surfaces 55a, respectively, of the translucent plate 55. A transparent plastic plate 56 for protecting the translucent plate 55 is disposed on the front surface of the translucent plate 55.

Next, a description will be given of an electric structure of the game apparatus according to this embodiment. A description of structures not having a direct relationship to the present invention is omitted.

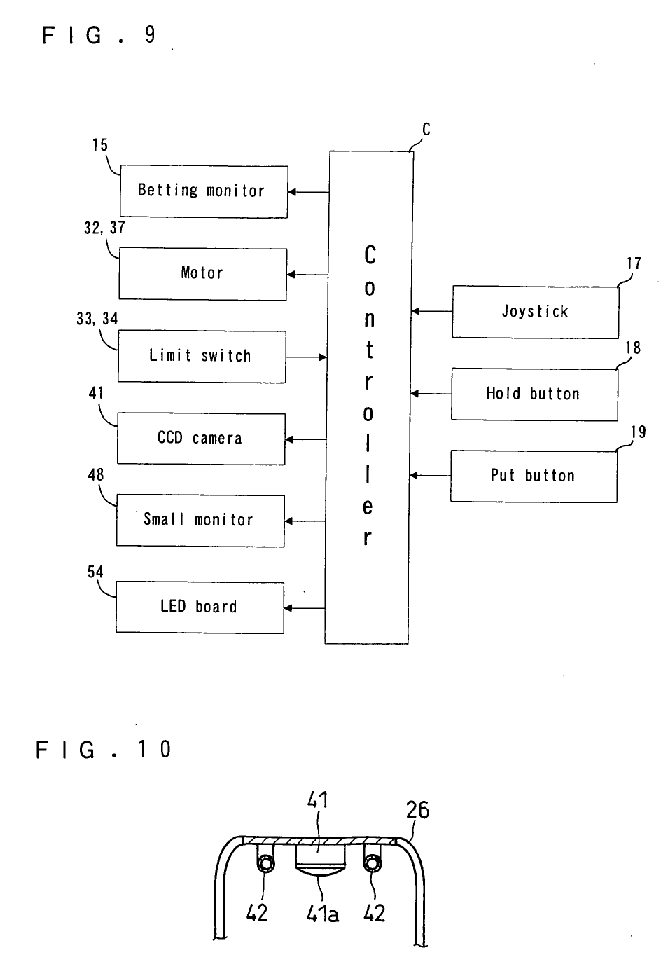

As shown in FIG. 9, the joystick 17, the hold button 18, and the put button 19 of each of the play corners P1 to P3 are connected to a controller C serving as a judging means.

Further, the betting monitor 15, the first motor 32, the first and second limit switches 33 and 34, the second motor 37, the CCD camera 41, the small monitor 48, and the LED board 54 are connected to the controller C.

The controller C composed of a central processing unit (CPU), memories, etc., controls the game apparatus, andanalyzes an image taken by the CCD camera 41.

In more detail, the controller C controls the game apparatus as follows.

The controller C allows the betting monitor 15 to display the betting board B, and urges a player to make a bet. The player plays a game while using the joystick 17, the hold button 18, and the put button 19. Based on the input from the joystick 17, the hold button 18, and the put button 19, the controller C performs predetermined game processing.

The controller C rotates the rotational plate 35 while controlling the driving of the second motor 37 so as to roll the dice put on the dice rolling surface 35a. Further, the controller C opens or closes the retractable dome 24 while controlling the driving of the first motor 32 in accordance with the dice rolling operation of the rotational plate 35. The position at which the retractable dome 24 is opened or closed is determined by bringing the connection pin 28 into contact with the first and second limit switches 33 and 34.

Further, the controller C commands the CCD camera 41 to photograph the dice when the dice stop being rolled and are stationary on the dice rolling surface 35a. The controller C then analyzes an image taken by the CCD camera 41, and judges spots shown by the dice. Based on a judgment result, medals corresponding to the bet rate thereof are given when it is judged that the contents of a bet selected by the player meet the result (i.e., when the game is a winning game). Simultaneously, the image taken thereby is displayed on the small monitor 48, and, based on the judgment result, the electronic display panel 50 electronically displays information in accordance with the spots shown by the dice.

Next, a description will be given of the operation of the game apparatus according to this embodiment.

In this embodiment, as a premise based on which the player plays a game, the rotational plate 35 is always rotated in a fixed direction. Additionally, although three dice are used in this embodiment, as a matter of course, a number other than three can be used.

When the player can make a bet, the rotational plate 35 is rotated at low speed, and the retractable dome 24 is in an open state as shown in FIG. 3, so that the player can directly see the dice. When the rotational plate 35 is rotated at low speed, the dice are in a stopped state. The history of spots shown by the dice for ten games in the past is displayed on the electronic display panel 50. A real-time image being taken by the CCD camera 41 is displayed on the small monitor 48. Thereafter, the rotational plate 35 starts being rotated at high speed when betting is closed (in this embodiment, the closure of betting is imparted from a speaker not shown). In response thereto, the retractable dome 24 is closed (see FIG. 4). The small monitor 48 changes the information displayed thereon to, for example, information (so-called bonus spots) about a gain to be given to the player. The dice stopped on the dice rolling surface 35a start being rolled by rotating the rotational plate 35 at high speed, and spots are changed. At this time, the dice interfere with the rod 40, and are further rolled. After the rotational plate 35 is rotated at high speed for a predetermined time, the rotational plate 35 gradually shifts to low-speed rotation. In accordance therewith, spots shown by the dice are determined, and the dice are again stopped on the dice rolling surface 35a. When the rotational plate 35 is rotated at low speed, the rod 40 serves to push back the dice, which have been moved outwardly, to the periphery of the pillar 35b erected at the center of the dice rolling surface 35a. As a result, the dice are gathered around the pillar 35b at the center of the rotational plate 35. In other words, the distances of the dice from the center of the rotational plate 35 are made substantially equal to each other.

Thereafter, when the rotational plate 35 shifts to the low-speed rotation, and when the retractable dome 24 is closed as shown in FIG. 4, an image including an image of the upper sides of the dice is taken by the CCD camera 41. The image taken by the CCD camera 41 is then analyzed so as to judge spots shown by the dice. In other words, before the spots shown by the dice are indicated to the player, the controller C previously imports the image, and starts analyzing the spots. At this time, the dice are gathered around the pillar 35b on the dice rolling surface 35a, and become stationary in a state of being a little inclined as shown in FIG. 2 in accordance with the inclination of the dice rolling surface 35a. The upper sides of the dice substantially exactly face the wide-angle lens 41a, so that the shape of each of the dice appearing on the image taken by the CCD camera 41 is obtained as a nearly square shape having almost no distortion.

When an analysis of the spots is completed, the retractable dome 24 is opened. In response to the opening of the retractable dome 24, the image taken by the CCD camera 41 is displayed on the small monitor 48, and is indicated to the player (in this embodiment, the image is displayed slightly later than the dome 24 is opened). Predetermined processing is performed in accordance with the winning or losing of the player. The spots in the present game are displayed on the electronic display panel 50 as a most significant piece of display information. In other words, in accordance with the fixation of the present spots, the historical data about spots shown by the dice for ten games in the past are moved down one by one, and the least significant record of the spots is dropped off (is deleted)

With this structure, the following effects are achieved in this embodiment.

(1) The dice are gathered near the center of the dice rolling surface 35a in accordance with the inclination thereof, and are photographed by the CCD camera 41 disposed above the dice. Therefore, the dice never disappear out of the field angle of the camera without being scattered.

(2) The dice are stationary while being inclined around the pillar 35b in accordance with the inclination of the dice rolling surface 35a, and all of the upper sides of the dice substantially exactly face the wide-angle lens 41a. Therefore, the shape of each of the dice appearing on the image taken by the camera is obtained in nearly square shape having almost no distortion. Therefore, in an image analysis, spots shown by the dice can be more accurately read.

(3) The cylindrical pillar 35b is disposed at the center (i.e., at the lowest position) of the dice rolling surface 35a, and the wide-angle lens 41a of the CCD camera 41 is disposed above the center of the pillar 35b. The dice that have been rolled to a stop are brought into contact with the pillar 35b, and are gathered therearound. In other words, the dice are each placed at equal distance from the center of the dice rolling surface 35a with the pillar 35b therebetween, and the wide-angle lens 41a of the CCD camera 41 is disposed above the center of the dice rolling surface 35a. Therefore, the three dice appearing on the image taken by the camera are placed in a well-balanced manner, and hence spots shown by the dice can be easily confirmed by the small monitor 48.

(4) The dice are reliably rolled while interfering with the rod 40 when the rotational plate 35 is rotated at high speed, whereas the dice are reliably pushed toward the pillar 35b by means of the rod 40 when the rotational plate 35 is rotated at low speed. Therefore, the dice, which cannot be easily maintained and checked because the dice are enclosed in the transparent dome 23, can be reliably rolled and stopped.

(5) Since the retractable dome 24 is closed when the dice are rolled, unnecessary light that acts as an outside noise against an analysis is blocked, and hence accuracy in analyzing the spots shown by the dice is improved.

(6) Since the retractable dome 24 is closed when the dice are rolled, a player cannot see the dice, and hence the amusingness of the game increases. In this case, the CCD camera 41 is also shielded by the retractable dome 24, an image of the upper sides of all dice can be accurately and reliably taken in although the CCD camera 41 is disposed very near the dice (i.e., at the lower part of the arch 26). Therefore, an accurate judgment can be made.

(7) Since the wide-angle lens 41a is attached to the CCD camera 41, the upper sides of all dice can be captured into the field angle even if the CCD camera 41 is disposed very near the dice.

The present invention can be embodied as follows.
Although the dice are rolled in accordance with the rotation of the rotational plate 35 in the foregoing embodiment, the dice may be rolled by another means.
The shape and the material of the rod 40 used as a contact member are not limited to those mentioned above. Additionally, in the present circumstances, the rod 40 is not an indispensable element.
The characteristic of the wide-angle lens 41a can be changed according to a distance from the dice.
The shape, angle, etc., of the dice rolling surface 35a can be changed.
The shape and the mechanism of the retractable dome 24 serving as a shielding member are not limited to those mentioned above.
The retractable dome 24 is not necessarily needed additionally, the opening and closing mechanism is not limited to that mentioned above.
The photographing means is not limited to the CCD camera 41.
The betting board B displayed on the betting monitor 15 is an example.
The small monitor 48 is not necessarily needed. additionally, the contents to be displayed on the small monitor 48 are not limited to those of the foregoing embodiment.
The CCD camera 41 is not necessarily disposed exactly above the center of the rotational plate 35.
A play medium for a player is not limited to the joystick 17 shown in the foregoing embodiment. For example, a track ball may be used to specify a betting position.
Although the rotational plate 35 is always rotated in the foregoing embodiment, the rotational plate 35 may temporarily stop before making a bet.

Besides, the present invention can be carried out in a modified manner within the scope not departing from the spirit of this invention.

### INDUSTRIAL APPLICABILITY

As described above, according to the present invention, since the dice are gathered near the lowest part of the concave part, the dice never disappear out of the field angle when an image is taken by the photographing means. Therefore, the present invention is useful in the fact that the dice can be reliably captured as an image even if the photographing means is disposed near the dice.

What is claimed is;:

1. A dice game apparatus comprising:
a dice rolling means for rolling dice so as to change spots shown by the dice and then stopping the dice again;
a photographing means for photographing the dice from a predetermined direction, the dice having been rolled by the dice rolling means and then having been stopped with given spots; and
a judging means for judging spots shown by the dice based on image data obtained by the photographing means;
wherein a predetermined profit is given to a player who has placed a bet on the given spots shown by the dice, based on a judgment result produced by the judging means;
wherein the rolling means has a rolling surface on which the dice are put and rolled, the rolling surface being inclined downwardly from an outer periphery thereof toward a center thereof; and
wherein the photographing means takes an image including upper sides of the dice gathering at a lower position of the rolling surface from above the rolling surface.

2. The dice game apparatus of claim 1, wherein the rolling surface and the photographing means can be shielded by a shielding member when the dice are rolled, and the dice are photographed while being shielded by the shielding member.

3. The dice game apparatus of claim 1, wherein the dice are stopped in a state of being inclined in accordance with an inclination of the rolling surface, and the dice are stationary while the upper sides of the dice are substantially exactly facing the photographing means.

4. The dice game apparatus of claim 3, wherein the photographing means is disposed above a lowest position of the rolling surface.

5. The dice game apparatus of claim 4, wherein, when a plurality of dice are used, the dice to be stopped on the rolling surface are each rolled to a stop at a substantially equal distance from a reference point.

6. The dice game apparatus of claim 5, wherein the rolling surface and the photographing means can be shielded by a shielding member when the dice are rolled, and the dice are photographed while being shielded by the shielding member.

7. The dice game apparatus of claim 6, wherein the photographing means is a CCD (Charge-Coupled Device) camera, the CCD camera has a wide-angle lens.
